(19) United States
(12) Patent Application Publication
(10) Pub. No.: US 2018/0079058 A1
(43) Pub. Date: Mar. 22, 2018

(54) Faucet Wrench

(71) Applicant: Lance Humphries, Ajax (CA)

(72) Inventor: Lance Humphries, Ajax (CA)

(21) Appl. No.: 15/272,371

(22) Filed: Sep. 21, 2016

(51) Int. Cl. B25B 13/50; B25B 13/48

(52) U.S. Cl. CPC B25B 13/5091; B25B 13/481

(57) ABSTRACT

A wrench for engaging a faucet wing nut attaching a faucet from an underside of a sink is disclosed. The wrench consists of an elongated member having opposite first and second ends and opposite first and second sides, a pair of first and second tabs projecting from the first end of the elongated member, the pair of tabs configured to engage flanges formed on the faucet nut. The elongated member has a semi-circular concave profile having a central axis, the concave surface configured to receive the hose and position it in coaxial alignment with the semi-circular concave profile of the elongated member, the pair of first and second tabs formed on the first and second sides of the elongated member, the tabs being parallel to the central axis.

### CROSS REFERENCE TO RELATED APPLICATION

This application claims priority from corresponding provisional patent application Ser. No. 62/221,732 filed Sep. 22, 2015, the entirety of which is incorporated herein by reference.

### FIELD OF THE INVENTION

The present invention relates generally to tools, in particular wrenches. More specifically, the present invention is related to a wrench for tightening or loosening the winged flange nuts used to secure a faucet in place.

### BACKGROUND OF THE INVENTION

Faucet securing nuts (faucet nuts) in common use are primarily of two configurations. They are a flanged “wing nut”, with 2 or 4 wings in opposing positions around the circumference. Engaging these faucet nuts to either tighten or loosen them is often very difficult because they are located underneath the faucet and because there is usually a water supply line mounted in coaxial alignment with the faucet nut. The water supply line makes it very awkward to access the faucet nut, usually requiring the individual installing or servicing the faucet to use his or her bare hands to engage the faucet nut. An improved tool which permits easy access to the faucet nut in the presence of the water supply line is therefore required to make the job easier, particularly in a constricted space.

### SUMMARY OF THE INVENTION

In accordance with one aspect of the present invention, there is provided a wrench for engaging a faucet wing nut attaching a faucet from an underside of a sink. The wrench consists of an elongated member having opposite first and second ends and opposite first and second sides, a pair of first and second tabs projecting from the first end of the elongated member, the pair of tabs configured to engage flanges formed on the faucet nut. The elongated member has a semi-circular concave profile having a central axis, the concave surface configured to receive the hose and position it in coaxial alignment with the semi-circular concave profile of the elongated member, the pair of first and second tabs formed on the first and second sides of the elongated member, the tabs being parallel to the central axis.

In accordance with another aspect of the present invention, the elongated member has a curved cross sectional profile, with the curvature of the cross sectional profile of the elongated member configured to receive the water supply hose and position the tabs on either side of the water supply hose.

In accordance with yet another aspect of the present invention, the elongated member has elongated first and second flanges extending along a length of the elongated member on the first and second sides of the elongated member, respectively, the first and second tabs being extensions of the first and second flanges.

In accordance with other aspects of the present invention the wrench further includes an aperture formed on the second end of the elongated member for receiving a leveraging bar for apply additional torque to the elongated member. The wrench further includes a nut socket sized to receive a hose nut mounted on an end of the water supply hose.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a perspective view of a wrench made in accordance with aspect of the present invention.

FIG. 2 is a cross sectional (profile) view of the wrench shown in FIG. 1.

FIG. 3 is a perspective view taken from the side of the wrench shown in FIG. 1.

FIG. 4 is a bottom view of a four flanged faucet wing nut showing the use of the tab portions of the wrench shown in FIG. 1.

FIG. 5 is a side view of a faucet showing the use of the wrench shown in FIG. 1 to engage the faucet nut.

In the drawings like characters of reference indicate corresponding parts in the different figures.

### DETAILED DESCRIPTION OF THE INVENTION

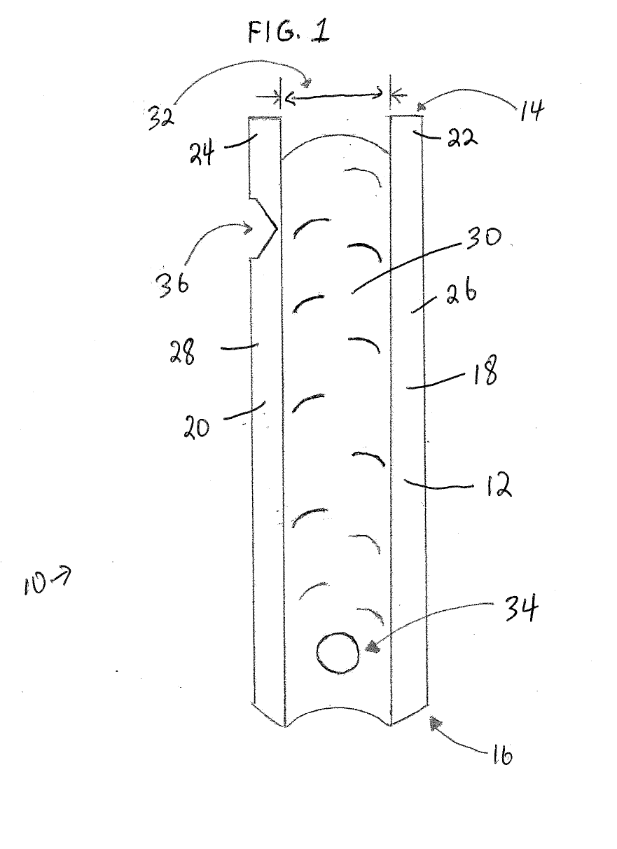

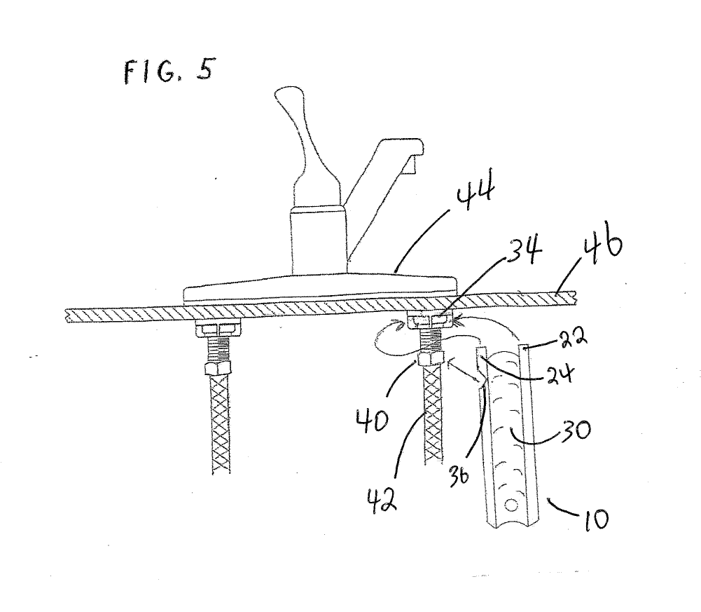

Referring to FIG. 1, the present invention is a wrench, shown generally as item 10, having an elongated member 12 with opposite first end 14 and second end 16 and opposite first and second sides 18 and 20, respectively. A tool head is formed on first end 14 consisting of a pair of first and second tabs (fingers) 22 and 24, respectively separated by a gap 32. Gap 32 is dimensioned to permit at least a portion of wing faucet nut 34 (see FIG. 5) to fit between tabs 22 and 24. Preferably, gap 32 is dimensioned to be slightly greater than the width of a water supply hose 42 (see FIG. 5). Elongated flanges 26 and 28 are formed at sides 18 and 20, respectively, with tabs 22 and 24 being extensions of flanges 26 and 28. Concave portion 30 extends between flanges 26 and 28. Flanges 26 and 28 are parallel to each other. Aperture 34 is formed on concave portion 30 adjacent end 16 and is dimensioned such that a screw driver (not shown) may be passed into the aperture to be used as a lever arm to apply additional torque to the elongated member. Nut engaging socket 36 is formed adjacent end 14 and is dimensioned to engage with the size of nuts generally used at the coupling end of water supply lines for faucets (FIG. 5 #42).

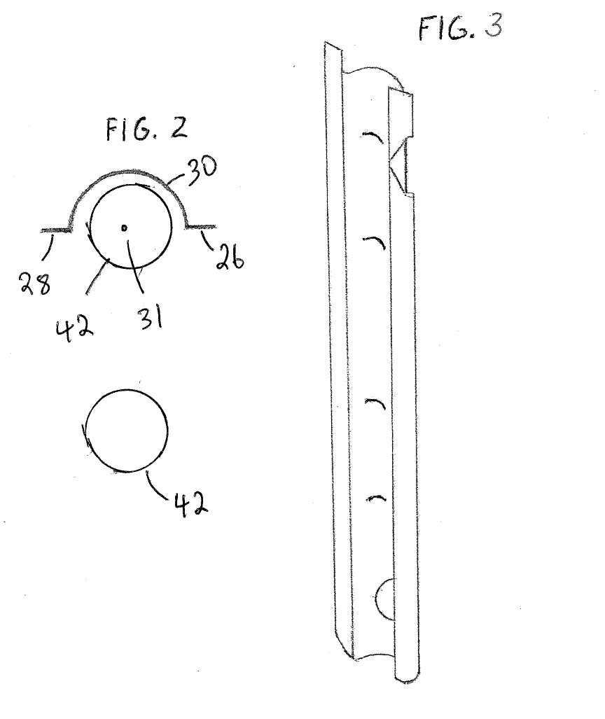

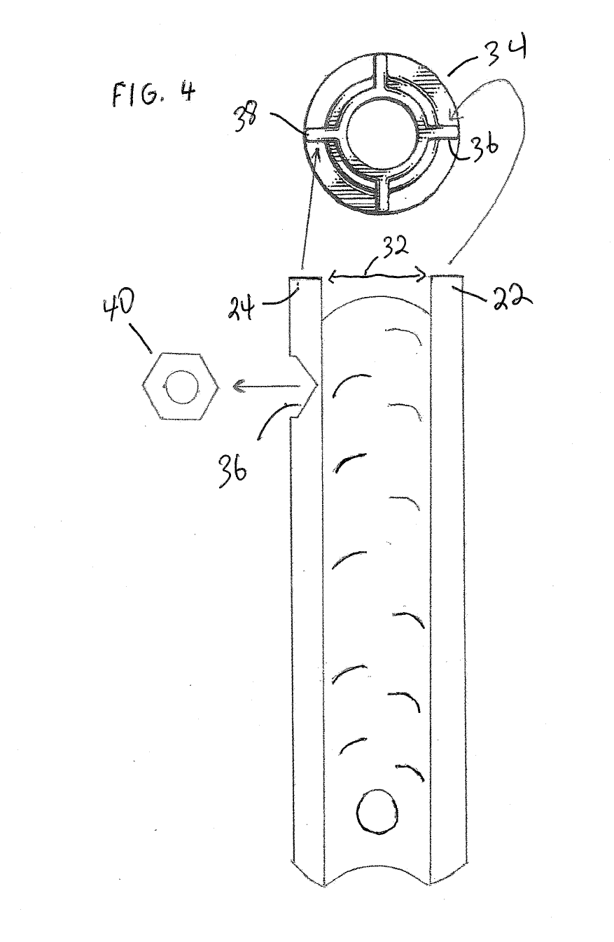

As better seen in FIG. 2, concave portion 30 is sufficiently curved such that it can receive hose 42 and the hose can be positioned between flanges 26 and 28 when the concave portion is longitudinally placed against the hose. Preferably, concave portion 30 has a semi-circular profile with a central axis 31. Flanges 26 and 28 extend away from concave portion 30 and are parallel to each other. Concave portion 30 permits the flanges 26 and 28 to be positioned very close to the centre of hose 42 so that the hose is as close to being coaxial aligned with axis 31 as possible. Furthermore, flanges 26 and 28 and the curvature of concave portion 30 add structural rigidity to the elongated member.

As best seen in FIG. 4, wing faucet nut 34 has a plurality of opposing flanges (either 2 or 4). Gap 32 is dimensioned to position tabs 22 and 24 so as to engage opposing flanges 36 and 38 to permit torque to be applied to the flanges of the nut. Socket 36 is sized to engage nut 40 which is often found at the end of water supply hoses.

The operation of wrench 10 shall now be described with reference to FIG. 5. Faucet 44 is mounted to a counter top or sink 46 with faucet nut 34 used to secure an end of water supply hose 42 to the underside of the faucet. Wrench 10 can be used to engage nut 34 by placing concave surface 30 longitudinally against water supply hose 42 such that the water supply hose and the elongated member of the wrench are coaxially aligned. The gap separating tabs 22 and 24 permit the tabs to engage the flanges of nut 34 with the nut positioned as close to possible to being coaxially aligned with the concave surface 30. By placing nut 34 coaxially aligned with concave surface 30, tabs 22 and 24 can engage opposing flanges on opposite sides of nut 34 allowing the user to more efficiently apply torque to nut 34 without damaging the nut. Placing nut 34 coaxially between tabs 22 and 24 requires hose 42 to be placed in coaxial alignment with concave surface 30. Concave surface 30 allows the coaxial alignment of tabs 22 and 24 with nut 34. Also, the wrench can be used to actuate nut 40 by engaging nut 40 using socket 36.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims

Therefore, what is claimed is:

1. A wrench for engaging a faucet nut attaching a faucet to an underside of a sink adjacent a hose, the faucet nut having a plurality of flanges symmetrically positioned on the faucet nut, the wrench comprising an elongated member having opposite first and second ends and opposite first and second sides, first and second tabs projecting from the first end of the elongated member, the first and second tabs configured to engage the flanges of the faucet nut, the elongated member having a concave surface with a semi-circular concave profile having a central axis, the concave surface configured to receive the hose and position it in coaxial alignment with the semi-circular concave profile of the elongated member, the first and second tabs formed on the first and second sides of the elongated member, the tabs being parallel to the central axis.

2. The wrench of claim 1 wherein the concave surface is configured to receive the hose and position the tabs on either side of the hose.

3. The wrench of claim 1 wherein first and second elongated flanges are formed on the first and second sides of the elongated member, said first and second elongated flanges extending along a length of the elongated member from the first to the second ends.

4. The wrench of claim 3 wherein the first and second elongated flanges extend perpendicularly away from the concave surface.

5. The wrench of claim 4 wherein a first and second portion of the first and second elongated flanges formed at the first end form the first and second tabs.

6. The wrench of claim 1 wherein the first and second tabs are positioned to engage flanges of the faucet nut which are symmetrically opposed when the faucet nut is positioned between the first and second tabs.

7. The wrench of claim 1 wherein an aperture is formed on the second end of the elongated member.

8. The wrench of claim 3 wherein a nut socket is formed on one of the first and second elongated flanges.

9. A wrench for engaging a faucet nut attaching a faucet to an underside of a sink adjacent a hose, the faucet nut having a plurality of flanges symmetrically positioned on the faucet nut, the wrench comprising:
a. An elongated member having opposite first and second ends and opposite first and second sides with first and second side edges, respectively;
b. first and second tabs projecting from the first end of the elongated member, the first and second tabs configured to position the faucet nut partially between the first and second tabs and cause the first and second tabs to engage the flanges of the faucet nut;
c. the elongated member having a concave surface extending longitudinally between the first and second ends;
d. first and second elongated flanges projecting from the first and second side edges, respectively, said first and second flanges extending between the first and second ends of the elongated member;
e. the concave surface configured to receive the hose and position a portion of the hose between the first and second elongated flanges when the elongated member is placed longitudinally against the hose, the first and second tabs being configured to extend parallel to the hose when the elongated member is placed longitudinally against the hose.

10. A wrench for engaging a faucet nut attaching a faucet to an underside of a sink adjacent a hose, the faucet nut having a plurality of flanges formed thereon, the wrench comprising:
a. An elongated member having opposite first and second ends and opposite first and second sides with first and second side edges, respectively;
b. first and second fingers projecting from the first end of the elongated member, the first and second fingers separated by a distance sufficient to receive the faucet nut partially between the first and second fingers and permit the first and second fingers to engage the flanges of the faucet nut when the first end of the elongated member is positioned onto the faucet nut;
c. the elongated member having a concave surface extending longitudinally between the first and second ends;
d. first and second elongated flanges projecting from the first and second side edges, respectively, said first and second flanges extending between the first and second ends of the elongated member, and
e. the concave surface configured to receive the hose and position a portion of the hose between the first and second elongated flanges when the elongated member is placed longitudinally against the hose, the first and second tabs being configured to extend parallel to the hose when the elongated member is placed longitudinally against the hose.
